(19) United States
(12) Patent Application Publication
(10) Pub. No.: US 2020/0376491 A1
(43) Pub. Date: Dec. 3, 2020

(54) Portable urine detection device and method

(71) Applicants: Hong-Ping Deng, Shenzhen (CN); Bo Chen, Shenzhen (CN); Wei-Jie Du, Shenzhen (CN); Ting Liu, Shenzhen (CN); Zhan Fang, Shenzhen (CN)

(72) Inventors: Hong-Ping Deng, Shenzhen (CN); Bo Chen, Shenzhen (CN); Wei-Jie Du, Shenzhen (CN); Ting Liu, Shenzhen (CN); Zhan Fang, Shenzhen (CN)

(21) Appl. No.: 16/424,397

(22) Filed: May 28, 2019

(51) Int. Cl. B01L 3/00; G01N 31/22

(52) U.S. Cl. CPC B01L 3/523; G01N 31/22; B01L 3/5023; B01L 2200/025; B01L 2300/021; B01L 2200/18; B01L 2300/024; B01L 2300/08; B01L 2300/023; B01L 2200/16

(57) ABSTRACT

A portable urine detection device and method is disclosed by the invention which relates to the technical field of urine detection. The invention includes a detection device and a cloud backstage system, of which the detection device comprises a shell, a slot component, a fixed component and several test strips. The circuit board is fixed in the shell. Several LED lamp beads, a camera module, a first algorithm module, a second algorithm module, a third algorithm module and a fourth algorithm module are fixed on one surface of the circuit board. One side of the circuit board is provided a USB port; one side of the USB port penetrates one side of the shell; the other side of the shell is provided with an opening; one side of the shell is connected with a smart phone through a USB port and an OTG data line. The fixed component comprises a bottom plate. According to the invention, the problems of overlarge volume, incapability of universal use and higher cost of the existing urine detection device are solved by designing a novel urine detection structure which is designed by a corresponding algorithm module that connected with the cloud.

### TECHNICAL FIELD

The invention belongs to the technical field of urine detection, in particular to a portable urine detection device and method.

### BACKGROUND ART

Urine index test is a very common medical test method. At present, there have been some portable urine index testing equipment at home and abroad. However, they still have the following disadvantages: 1. The convenience of urine testing equipment is seriously insufficient: the equipment is too large in size or too heavy to carry, and it is not convenient to place at home for testing. 2. The cost of urine testing equipment is too high to be suitable for mass popularization: the testing equipment is a completely independent equipment, including information acquisition unit, calculation unit, mechanical transmission device, output or printing module, which leads to high equipment cost and is difficult for ordinary families to afford, thus seriously affecting the popularization of the equipment. Moreover, too complicated internal structure is not conducive to technological upgrading. In terms of user experience, there are many problems: the beauty of urine testing equipment is not enough, which affects the visual perception of users. 3. The operation of software and hardware is complicated, which is difficult for elderly patients to master. In the process of use, the prompt information is not enough and the user is required to guess the test error repeatedly. The lack of intelligent reminding of the testing time may lead to missing the best testing time. The lack of automatic monitoring of the test strip installation process makes it impossible to carry out early warning and prompt for abnormal situations such as the test strip is not inserted in place, upside down, back and forth, or is not inserted, or is deviated or exceeds the slot position. The configuration of network modules is complicated, and elderly patients cannot complete the configuration independently. Moreover, due to the complete dependence on the network module on the urine test equipment, the equipment cannot be used in remote areas without network. Data is not stored or can only be stored locally. Can't communicate with doctors and patients, also can't get useful related treatment information. 4. The detection result of urine index is unstable: insufficient stability of illumination, uneven illumination, and no interference of shielding external illumination, which affect the detection process. It is not convenient to clean, and it is easy to change the detection result due to urine residue, which also leads to peculiar smell and affects the user experience. The unreasonable design of the equipment structure is easy to make physical contact with urine test paper strips, thus causing pollution between test strips and affecting the results. The accuracy of the test result is not enough, which is different from the actual index. If the above problems are not solved, it will seriously affect the application of urine detector in the daily life of ordinary patients, making urine detector unable to become a popular product.

### SUMMARY OF THE INVENTION

The invention aims to provide a portable urine detection device and a portable urine detection method. By designing a novel urine detection structure, designing a corresponding algorithm module and connecting with a cloud, the problems of overlarge volume, incapability of universal use and higher cost of the existing urine detection device are solved.

In order to solve the above technical problems, the invention is realized through the following technical scheme:

The invention relates to a portable urine detection device, which comprises a detection device and a cloud background system, of which the detection device comprises a shell, a slot component, a fixing component and several detection strips;

A circuit board is fix in that shell, several LED lamp beads, a camera module, a first algorithm module, a second algorithm module, a third algorithm module and a fourth algorithm module are fix on one surface of the circuit board, one side of the circuit board is provided with a USB port, one side of the USB port penetrates through one side of the shell, the opposite side of the shell is provided with an opening, and one side of the shell is connected with a smart phone through a USB port and an OTG data line;

The fixing component comprises a bottom plate, of which the bottom plate is fixedly connected with one surface of the inner bottom of the shell through bolts; one surface of the bottom plate is fixedly provided with a positioning door, a group of side clamping buckles, a group of cylindrical bulges and a baffle plate buckle; the positioning door is arranged on one side of the shell close to the opening of the detection box; a movable clamping spring is arranged on the cylindrical bulges; a group of side clamping buckles and the cylindrical bulges are symmetrically arranged on one surface of the bottom plate; the side clamping buckles and the baffle plate buckles are in inverted L-shaped structures; one end of the movable clamping spring is fixedly connected with one side of the side clamping buckles; and the baffle plate

The slot component comprises a main board, of which a shroud is arranged on the peripheral side surface of the main board; a group of U-shaped grooves which are symmetrical with each other are respectively arranged on one opposite side of the shroud; the U-shaped grooves are in clearance fit with cylindrical protrusions; a wrapping structure is fixed on the top of the shroud; a strip-shaped depression is formed in the middle of the main board; and a circular depression is formed in the middle of the strip-shaped depression.

Further, the detection paper strip comprises a test paper sheet and a thin substrate, of which the thin substrate comprises a rectangular plate part and a handle part; the test paper sheet is fixed on the rectangular plate part; several small test strips are arranged on the test paper sheet; a black outer frame is arranged on one surface of the rectangular plate part and at positions outside the small test strips; and a prompt line, a prompt icon and a patch are arranged in the middle of the test paper sheet.

Further, the number of the LED lamp beads is four, the four LED lamp beads are distributed in four corners of the circuit board in a rectangular shape, and the camera module is opposite to the middle position of the slot component.

Furthermore, the shell has a cube structure, the peripheral side surface of the shell is provided with a frosted layer, corners of the shell are provided with rounded corners, the top of the shell is fixed with a switch, and the switch is electrically connected with a circuit board.

Further, the cloud background system includes a cloud database, a doctor side software module, a patient side software module, a friend side software module, a social networking module and a customer service subsystem.

A portable urine detection method comprises the following steps:

SS01 judges the positive and negative of the test paper sheet by observing the prompt icon and the patch, wets the test paper sheet with urine, and places the test paper sheet on the main board to form suction force with the slot component through the adsorption effect of water;

SS02 inserts the slot component for installing the test paper sheet into the shell in alignment with the opening on one side of the shell, the slot component passes through the positioning door and falls between the side clamping buckle and the baffle clamping buckle, meanwhile, the U-shaped slot can be clamped on one side of the cylindrical projection, and when the movable clamping spring makes a sound, the slot component is installed completely;

SS03 takes out the OTG data line and connects the smart phone with the USB port on the circuit board through the OTG data line. The smart phone can supply power to the circuit board. At this time, the camera module and LED lamp bead are started.

SS04 locates each small test strip on the test paper sheet in the image through the first algorithm module, locates the test paper sheet through the second algorithm module and judges whether the insertion direction is skewed, can carry out color correction on each pixel in the test paper sheet image through the third algorithm module, and can identify the color in the test paper sheet through the fourth algorithm module to obtain the final urine index detection result;

SS05 can transmit the data to the smart phone through OTG data line, and the smart phone can observe the detection results and transmit them to the cloud database.

Further, the specific steps of the first algorithm module in SS04 are as follows:

SS0411: binarizing the image with threshold value;

SS0412: Use the largest general area in the binary map as the test strip area;

SS0413: binarization is used to obtain the black outer frame of the test strip in the test strip area;

SS0414: Warning if the number of black frames is less than 16;

SS0415: binarizing inside each black outer frame to obtain a test strip area;

SS0416: further refine the test strip area by etching operation.

Further, the specific steps of the second algorithm module in SS04 are as follows:

SS0421: Filter out the part overlapped with the image edge from the outer contour of the test strip to obtain the intersection point of the outer contour and the image boundary as the lower left corner and the lower right corner of the test strip;

SS0422: Calculate the included angle between each contour point and the contour point with front-back distance N;

SS0423: Take the two contour points with the smallest included angle value among all contour points as the upper left corner and upper right corner of the test strip;

SS0424: connect the lower left corner, the upper left corner, the upper right corner and the lower right corner in sequence to judge whether the lines meet the parallel and vertical relationship;

SS0425: judge whether the test paper is placed vertically.

Further, the specific steps of the third algorithm module in SS04 are as follows:

SS0431: 1 Minute Continuously Captures 20 Images with Urine Testing Device;

SS0432: calculate the average value of RGB three channels of each picture;

SS0433: find the median value of the average value of each channel in 20 maps;

SS0434: filter images with large difference between average value and median value;

SS0435: calculate the average image of the remaining images;

SS0436: filtering color noise in average image;

SS0437: filter the bright reflection points caused by the light source;

SS0438: Filter Shadow Pixels and Low Brightness Pixels;

SS0439: filtering pixels with large gradient values;

SS04310: all gray pixels on the bottom plate of the test strip are detected;

SS04311: Calculate an average value for all gray point pixels to obtain a target value for color correction;

SS04312: use the target value to correct each pixel and color in RGB channels at the same time;

SS04313: average filters pixels with corrected color values higher than 255.

Further, the specific steps of the fourth algorithm module in SS04 are as follows:

SS0441: collecting test paper samples by manually configuring reagents with different concentrations;

SS0442: collect users' real test samples through the network;

SS0443: cut a 0.5 mm wide area around each test strip;

SS0444: HSV, RGB and normalized RGB color spaces are selected as features at the same time.

SS0445: comprehensively calculating the color similarity of two pixels from three color spaces;

SS0446: Set up a color subset for each detection item, and use the mean shift algorithm to complete the clustering of color values, and set up a Gaussian model for each color subclass;

SS0447: Analyze each pixel on the current test strip to determine the probability that it belongs to each color subclass;

SS0448: Gaussian model is used for noise filtering, and if the number of remaining pixels is less than 10%, early warning is given;

SS0449: Use multiple snap shots to compare the image changes of test paper and determine the most accurate time for identification;

SS04410: Synthesize all pixels on the current test strip to obtain the probability that the test strip belongs to each reference class and obtain the final recognition result.

The invention has the following beneficial effects:
1. The size of the invention is not more than 10 cm*10 cm*10 cm and the weight is not more than 200 grains, which is very suitable for patients to carry out tests at home, does not occupy too much space, is convenient to carry, and can also be used during travel.
2. The invention controls the cost of urine test equipment, retains the image acquisition unit and lighting unit in the equipment, and then connects with the smart phone by OTG data line, so the mechanical transmission device can be changed into a manual slot by means of the computing unit and the display unit of the smart phone, the complexity of the equipment is greatly reduced, the cost is also greatly reduced, and the condition that the ordinary people can consume is fully met.
3. The invention has beautiful appearance design, improves the visual sense of users, has simple operation and extremely simplified steps, and the data are stored in the local and cloud of the mobile phone at the same time. Users can conveniently see the detection results on the mobile phone or on the web, and can also view all the detection results in history. In addition, the cloud system matched with the detection equipment also supports the social interaction between the patients and doctors and patients, and the cloud system can send highly relevant feedback information and medical information according to the body state of the patients.
4. The urine test equipment according to the present invention has a closed casing, which can shield external illumination interference. The inside of the box body is illuminated by a white light LED light source, the illumination is stable and uniform, the slot for installing the test paper can be disassembled and cleaned independently, the equipment does not have physical contact with the test paper, therefore urine pollution cannot be caused, and the detection results of each index item completely reach the detection precision of professional equipment in the hospital.

Of course, the implementation of any product of the present invention does not necessarily need to achieve all the advantages mentioned above at the same time.

### BRIEF DESCRIPTION OF DRAWINGS

In order to more clearly explain the technical scheme of the embodiment of the present invention, the following will briefly introduce the drawings needed for the description of the embodiment. Obviously, the drawings in the following description are only some embodiments of the present invention. For a person of ordinary skill in the art, on the premise of not paying creative labor, other drawings can be obtained according to these drawings.

FIG. 1 is a schematic structural diagram of a portable urine detection device of the present invention;

FIG. 2 is a schematic structural view of FIG. 1 with the housing base removed;

FIG. 3 is a structural plan view of the fixing component;

FIG. 4 is a schematic structural diagram of the slot component;

FIG. 5 is a schematic structural view of the fixing component;

FIG. 6 is a schematic structural diagram of a test paper strip;

In the drawings, the parts represented by each reference number are listed as follows:

1-Housing, 2-Slot Component, 3-Fixing Component, 4-Test Paper Strip, 101-Circuit Board, 102-LED Beads, 103-Camera Module, 104-USB port, 105-Opening, 106-Switch, 201-Main Board, 202-Fence, 203-U-Groove, 204-Wrapping Structure, 205-Strip Recess, 206-Circular Recess, 301-Floor, 302-Positioning Door, 303-side clip, 304-cylindrical projection, 305-baffle clip, 306-movable clip spring, 401-test strip, 402-thin substrate, 403-rectangular plate, 404-handle, 405-small test strip, 406-black outer frame, 407-prompt line, 408-prompt icon, 409-patch.

### DETAILED DESCRIPTION OF THE PREFERRED EMBODIMENT

In the following, the technical scheme in the embodiment of the present invention will be described clearly and completely with reference to the drawings in the embodiment of the present invention. Obviously, the described embodiment is only a part of the embodiment of the present invention, not all of the embodiments. Based on the embodiments of the present invention, all other embodiments obtained by those of ordinary skill in the art without creative labor are within the scope of protection of the present invention.

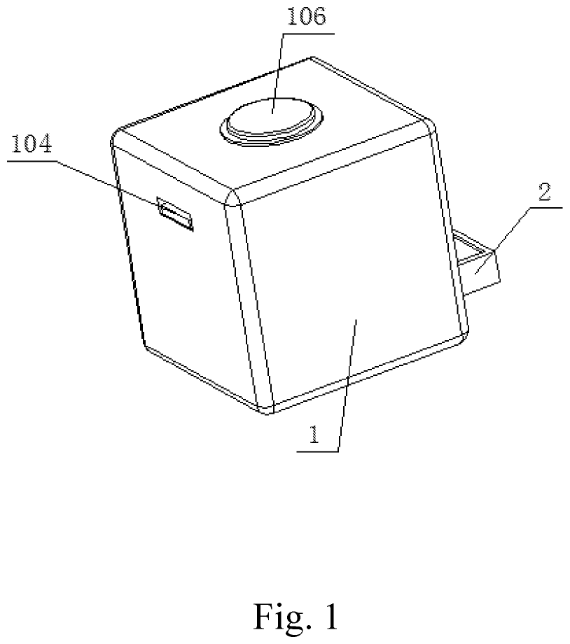

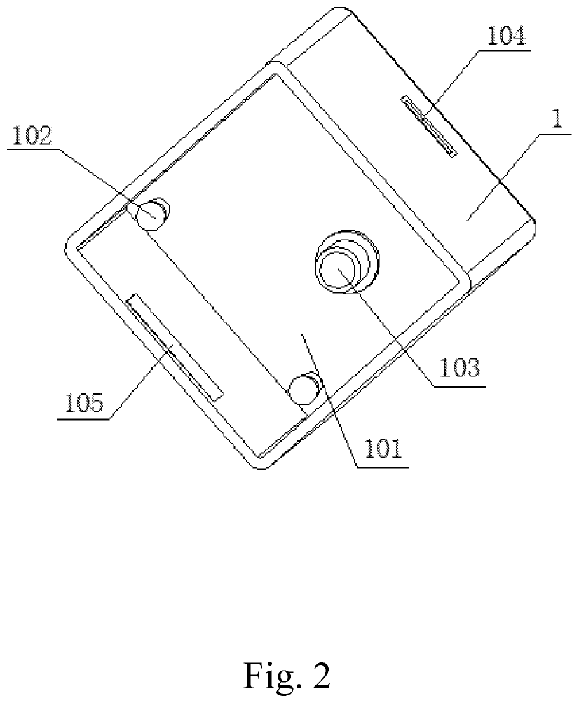

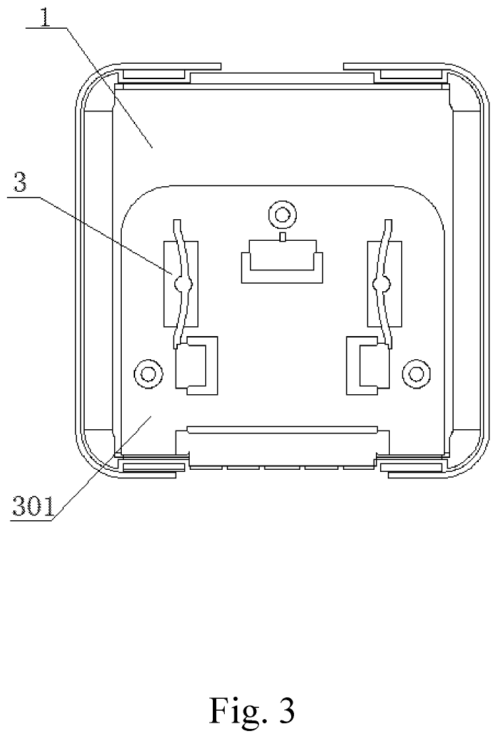

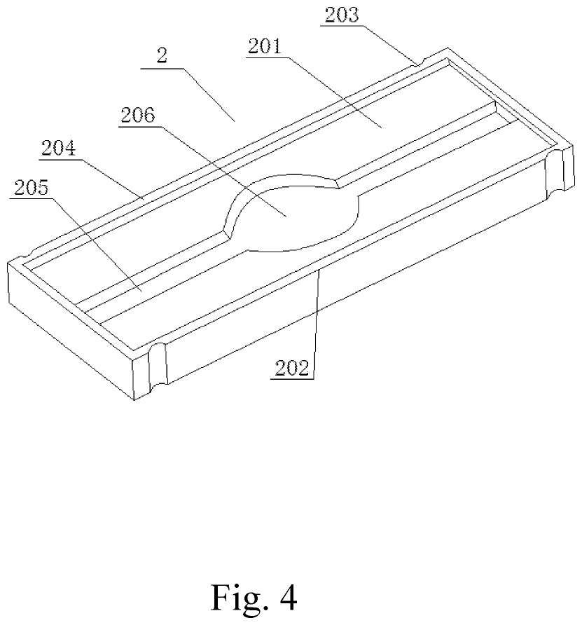

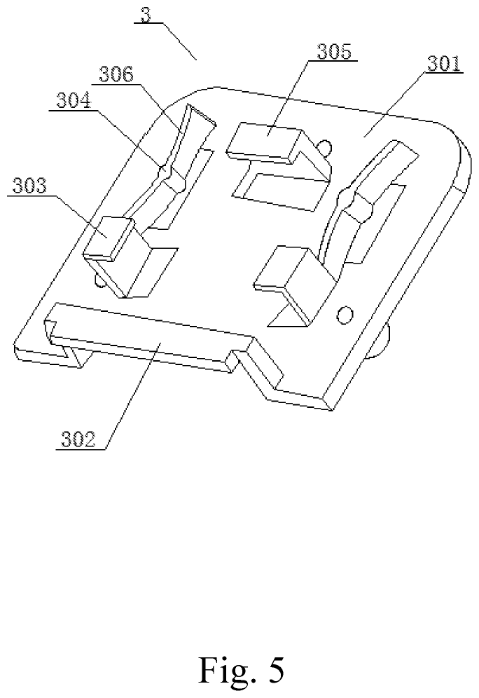

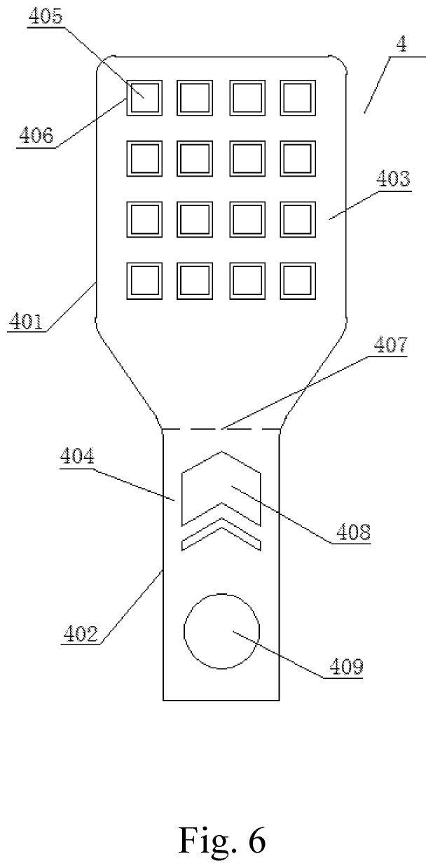

Referring to FIGS. 1-6, the present invention is a portable urine detection device including a detection device and a cloud background system. the detection device includes a housing 1, a slot component 2, a fixing component 3 and several detection strips 4.

A circuit board 101 is fixed in the housing 1, several LED lamp beads 102, a camera module 103, a first algorithm module, a second algorithm module, a third algorithm module and a fourth algorithm module are fixed on one surface of the circuit board 101, one side of the circuit board 101 is provided with a USB port 104, one side of the USB port 104 penetrates through one side of the housing 1, and the other side of the housing 1 is provided with an opening 105. One side of the shell 1 is connected with a smart phone through a USB port 104 and an OTG data line, the model of the LED lamp bead 102 is JYJHS-2835D082, the LED lamp bead 102 is parallel to the circuit board 101 to ensure that the illumination direction is the vertical direction of the shell 1, the camera module 103 comprises an optical lens and a photosensitive chip, the photosensitive chip is a CCD photosensitive chip or a CMOS photosensitive chip, the adopted chip model is HM2057, and the resolution of the camera image is 300-10 million pixels; When focusing on speed, a resolution of 300,000 pixels can be used; Focusing on accuracy, a resolution of 10 million pixels can be used, and camera module 103 communicates with smart phones using UVC protocol.

The fixing component 3 comprises a bottom plate 301, of which the bottom plate 301 is fixedly connected with one surface of the inner bottom of the shell 1 through bolts; one surface of the bottom plate 301 is fixed with a positioning door 302, a group of side snap fasteners 303, a group of cylindrical protrusions 304 and a baffle snap fastener 305; the positioning door 302 is arranged on one side of the shell 1 close to the detection box opening 105; and a movable snap spring 306 is arranged on the cylindrical protrusion 304. A group of side snap fasteners 303 and cylindrical protrusions 304 are symmetrically arranged on one surface of the bottom plate 301, the side snap fasteners 303 and the baffle snap fasteners 305 are all in an inverted L-shaped structure, one end of a movable snap spring 306 is fixedly connected with one side of the side snap fasteners 303, the baffle snap fasteners 305 are arranged on one side of the bottom plate 301 remote from the opening 105, and the positioning door 302 is used for guiding and fixing the slot component 2, so that the stability of the slot component 2 is improved;

The slot component 2 comprises a main board 201, of which the peripheral side surface of the main board 201 is provided with a shroud 202, one opposite side of the shroud 202 is provided with a group of U-shaped grooves 203 which are symmetrical with each other, the U-shaped grooves 203 are in clearance fit with the cylindrical protrusions 304, the top of the shroud 202 is fixed with a wrapping structure 204, the middle of the main board 201 is provided with a strip recess 205, and the middle of the strip recess 205 is provided with a circular recess 206, The enclosure 202 is 2-5 mm higher than the main board 201, and the thickness of the enclosure 202 is 0.5-1.5 mm The enclosure 202 enables the four sides of the slot component 2 to be surrounded, which can well prevent the test paper 4 from sliding out, and can ensure that the test paper 4 will not deflect during the insertion and installation process, thus playing a fixing role.

The test strip 4 comprises a test strip 401 and a thin substrate 402, of which the thin substrate 402 comprises a rectangular plate part 403 and a handle part 404, the test strip 401 is fixed on the rectangular plate part 403, several small test strips 405 are arranged on the test strip 401, 16 small test strips 405 are distributed in a 4 * 4 mode, a black outer frame 406 is arranged on one surface of the rectangular plate part 403 and positioned outside the small test strips 405, The middle of the test strip 401 is provided with a prompt line 407, a prompt icon 408 and a patch 409. The line width of the black outer frame 406 is 0 5 mm, and the distance between two adjacent black outer frames 406 is 1 mm The automatic detection device can obtain the accurate position of each small test strip 405 by detecting the position of the black outer frame 406 in the image.

Among them, the number of LED lamp beads 102 is four, and the four LED lamp beads 102 are distributed in four corners of the circuit board 101 in a rectangular shape, and the camera module 103 is opposite to the middle position of the slot component 2.

Among them, the shell 1 is of a cube structure. The shell 1 is made of opaque material and is sealed around to isolate external light interference. The side surface of the shell 1 is provided with a frosted layer. The corner of the shell 1 is provided with rounded corners. A switch 106 is fixed on the top of the shell 1. The switch 106 is electrically connected with the circuit board 101. The rounded corners are processed to prevent the shell 1 from wearing. The surface material of the shell 1 is frosted to improve the user's hand feeling.

The cloud background system comprises a cloud database, a doctor side software module, a patient side software module, a relatives and friends side software module, a social networking module and a customer service subsystem.

The specific contents and functions of the cloud database module are as follows: (1) all previous detection results of all users are stored in the cloud database. (2) Support manual processing of each test result: modify some or all data of a test record; Add a brand-new test record manually; Delete a test record that is considered wrong. (3) When the user changes the mobile phone, the system will automatically update the history detection record of the mobile phone terminal to maintain the consistency of the mobile phone terminal and cloud data: if the user logs in his own account on the new mobile phone, the cloud database detects the mobile phone number corresponding to the account. If the current mobile phone number is the new mobile phone number, all the history data of the user in the cloud database will be retrieved, packed and compressed, and then downloaded to the mobile phone for synchronous update. (4) user account management submodule: establishing an account management data table in a cloud database; Set up a record for each user's account number; In the record corresponding to the account number, any mobile phone number used by the account number is stored; Every time the user logs in, the mobile phone number will be sent to the cloud. The cloud program determines whether data synchronization is needed by judging whether the mobile phone number is the first occurrence in the user's record; If this is a new mobile phone number for the user, the mobile phone number needs to be saved into the record corresponding to the account.

Doctor-side software module: (1) The system is specially equipped with guiding doctors for each patient: the cloud system will automatically assign guiding doctors to patients, or the user will designate guiding doctors himself. Each doctor can instruct more than one patient. The system automatically sorts doctors according to their scores in the scoring module, and the ones with the highest scores are assigned first. (2) When the patient has a new test message, the doctor will send a message to remind him. (3) doctors check the patient's historical data and give advice and guidance.

3. Patient-side software module: (1) When the patient's mobile phone is offline, the test results can be saved and edited locally. (2) when the mobile phone is online, the synchronization of local data and cloud is automatically realized: if the mobile phone is offline for a period of time and then reconnected, the newly-appeared detection record needs to be automatically updated to the cloud; The test record edited by the patient on the mobile phone needs to be updated to the cloud. The patient updates the test record on the web browser, and also needs to be automatically updated to the cloud database and the mobile phone. After the patient changes the mobile phone, all detection records in the cloud need to be synchronized to the new mobile phone terminal, and offline data on the new mobile phone also need to be automatically updated to the cloud database. (3) The patient can view all the history test records of any test index item and all the index results of each test at the local end of the mobile phone. (4) When the detection time is approaching, the patient-side software will automatically remind the patient by means of voice, graphics, etc., so as to achieve the best effect of urine index detection. (5) Automatic voice broadcasting function of patient-side software module for patients. (6) management of multiple accounts on the same mobile phone: can be easily switched to their own accounts; After the detection result is obtained, the latest detection result of all users will be automatically traversed, and the most matching user found will be reminded whether the user needs to switch accounts automatically; The way the test record can be transferred to the correct account number. (7) Management of various test strips and various detection tasks: In the back-end database, necessary records and storage are made for the types of test strips used by patients and their detection tasks. (8) The patient condition information feedback submodule correspondingly provides feedback text content prepared in advance and corresponding information such as messages, medicines, treatment suggestions, health care products and the like according to the results of each detection index of the patient. (9) E-commerce submodule: Users can easily purchase consumables such as test paper strips and pay for them through online payment.

4. The software module at the relatives and friends' side is convenient for young people to guide the elderly patients to operate the urine test instrument in each step: (1) the online support function of relatives and friends: in the process of testing the patients, two pictures can be seen in real time on the software port at the relatives and friends' side: the shooting content of the mobile phone camera and the content of the mobile phone screen; After the online support function is started, relatives and friends can carry out real-time voice communication with patients to guide them. Relatives and friends can watch the real-time content of the camera in real time to guide patients to complete the operation of starting the detector, installing test paper strips, connecting data lines of mobile phones, installing test paper slots, etc. Relatives and friends can directly click the detection button in the software to replace the user for operation; It can also be guided by observing the patient's use of the software. (2) Patients should remind their relatives and friends in time if they have new detection information; (3) relatives and friends check the patient's historical test data.

5. Social module: it is used to realize mutual communication between doctors, patients, relatives and friends, patients and other roles (1). Social function sub-module for patient-doctor communication: the content that can be transmitted includes text, voice, pictures, video, real-time voice, real-time video, phone calls and so on. (2) The evaluation system of patients to doctors includes the following aspects: whether the guidance of doctors is timely; Whether the doctor's guidance has strong pertinence and whether the improvement effect is obvious; The doctor's service attitude is good or not; The scoring result is between 1 and 5 points; Other patients can know the doctor's service quality according to the score of each item of the doctor and the total score, thus making judgment. (3) guiding doctors' automatic recommendation and selection function: patients set their own distance from doctors, and doctors beyond this distance will not make selection; The default distance is 60 km ; ; Doctors within the distance range set by the patient are ranked according to the evaluation score from high to low; The doctor is good at the field, and the degree of coincidence with the detection index most concerned by the patient is ranked. For example, if a patient is concerned about the urine sugar index, doctors who are good at diabetes ranked first. Investigate the number of patients that doctors have instructed. If the number of patients who have been instructed exceeds the limit (for example, 30), guidance cannot be given.

6. Customer service subsystem: (1) open source voice recognition software CMU Sphinx is used to recognize voice information sent by patients; Developers and customer service personnel collect common high-frequency problems of users in advance. Classify all kinds of problems to ensure that they belong to the same problem, establish the text subset S_text, and update them in real time. (2) manually extracting keywords from high-frequency problems to build a keyword list. Statistics on the association probability between each keyword and the question: for the current keyword, traverse all candidate questions, and count the total number of occurrences in the text of the question; Calculating the occurrence probability of the current keyword in the current candidate problem; (3) The answers to each high-frequency question have been edited, and the intelligent algorithm can be called at any time to feed back to the user as the answers; (4) After the user submits the question, the intelligent algorithm extracts the keywords from the text information by comparing the text one by one. Looking up the table to obtain the probability that the keyword belongs to each problem, and establishing a probability histogram for all candidate problems; The probabilities of all keywords are superimposed in the histogram. The candidate problem with the highest probability is selected as the analysis result in the histogram. (5) Feedback the corresponding answer of the selected question to the patient. (6) If the user is still not satisfied with the answer, the answer will be given manually.

7. Patients chat and group function submodule, improve the frequency of communication between patients.

8. Automatic hot spot analysis function of patient group discussion content: researchers manually maintain a hot spot keyword list, keep the frequency of occurrence of each word for one month, and sort them according to the frequency from high to low; It is also necessary to maintain a list of non-hot words. Every time there is new chat content, the intelligent algorithm first calls Viterbi algorithm to segment the text. Extracting the 100 words with the highest frequency in the chat content of the day; Word-by-word analysis: if the current word is a hot word, update the frequency of occurrence of the changed hot word; Otherwise, if it is a non-hot word, it will not be processed. Otherwise, manually analyze the word to decide whether to add it to the hot word list; The top 20 words with the highest frequency in the hot word list are fed back to the research and development personnel to help them master the latest hot spots in the industry.

9. WeChat clocks in, and the friends circle shows: the test results are automatically released to the friends circle in the form of graphs, so that friends can know their physical state in time.

10. The cloud intelligent analysis module detects the abnormal situation of the urine glucose index result of the patient, specifically as follows: the algorithm automatically judges and analyzes the index result of the patient for nearly 3 days (4 times a day, 12 times in total) (taking the urine glucose index value as an example): (1) Setting the normal urine glucose threshold T=2.8 mmol/L; (2) If the test data X<2.8 mmol/L this time, it indicates that urine sugar is normal; (3) Otherwise, the historical detection data of the item of urine sugar in the database of the user is retrieved. If there is no record before this, and this test is the first test, the current record will be stored and the prompt result will be output. (4) Otherwise, the index results in the database for the past 3 days retrieved and the the average value of the index data is calculated; (5)

$$\frac{\vert X - \overline{X} \vert}{\overline{X}} < 10 \% ,$$

If it indicates abnormal urine sugar, but the trend is relatively stable. It is suggested to pay attention to diet and keep continuous monitoring. (6) Otherwise, abnormal fluctuation of urine sugar is suggested. It is suggested to further test blood sugar and adjust diet, and see a doctor in time when necessary depending on blood sugar test results. A portable urine detection method comprises the following steps:

SS01 judges the positive and negative of the test paper 401 by observing the prompt icon 408 and the patch 409, wets the test paper 401 with urine, and places the test paper 401 on the main board 201 to form suction force with the slot component 2 through the adsorption of water;

SS02 inserts the slot component 2 for installing the test strip 401 into the housing 1 in alignment with the opening 105 on one side of the housing 1. The slot component 2 passes through the positioning door 302 and falls between the side catch 303 and the baffle catch 305. At the same time, the U-shaped slot 203 can be caught on one side of the cylindrical projection 304. At this time, when the movable catch spring 306 makes a sound, the slot component 2 is installed completely.

SS03 takes out the OTG data line and connects the smart phone with the USB port 104 on the circuit board 101 through the OTG data line. The smart phone can supply power to the circuit board 101. At this time, the camera module 103 and the LED bulb 102 are started.

SS04 locates each small test strip 405 on the test strip 401 in the image through a first algorithm module, locates the test strip 401 through a second algorithm module and judges whether the insertion direction is skewed, color correction can be carried out on each pixel in the image of the test strip 401 through a third algorithm module, and color in the test strip 401 can be identified through a fourth algorithm module to obtain a final urine index detection result;

SS05 can transmit the data to the smart phone through OTG data line, and the smart phone can observe the detection results and transmit them to the cloud database.

The specific steps of the first algorithm module in SS04 are as follows: SS0411: binarize the image with threshold value;

SS0412: use the largest general area in the binary map as the test strip 401 area;

SS0413: a black outer frame 406 of the test strip 401 is obtained by binarization in the area of the test strip 401; SS0414: warning if the number of black frames 406 is less than 16;

SS0415: binarization is performed inside each black outer frame 406 to obtain a test strip 401 area;

SS0416: further refine the test strip 401 area by etching operation. The detailed steps are as follows: 1. Take an image with a urine test device, and then convert the color image Img_color into a gray image Img_gray; 2. Set the test strip detection binarization empirical threshold Th_strip to 100; 3, binarizing Img_gray to obtain a foreground image IMG forest: traversing each pixel point in Img_gray, if the brightness value of the pixel point is greater than Th_strip, setting the brightness value of the pixel at the corresponding position of IMG_forest to 255, otherwise, setting to 0; 4. Locate the outer frame of the test strip to obtain the region of interest map Img_ROI of the test strip. The specific steps are as follows: (1) analyzing the connected domain of the foreground image Img_fore; (2) If there is no connectivity domain, there is no test strip in the image field of view, and the urine detector algorithm stops; (3) filling the detected connected domain with internal holes; (4) calculating the area of each connected domain; The connected area with the largest area is taken as the area corresponding to the test strip; (5) If the area value of the maximum connected area is less than the minimum area threshold Th_area_bound (default is 10000), the user will be alerted. (6) In Img ROI, each pixel point located inside the outer frame of the test strip is set to 255, and the remaining pixels are 0; 5. Setting the binarization empirical threshold Th_bound of the black outer frame detection of the test strip to 150; 6. Combining Img_gray and Img ROI for binarization to obtain foreground image IMG FORE2: (1) traversing every pixel point in Img gray, if the brightness value in Img_ROI map corresponding to the pixel position is 0, then processing is not performed; Otherwise, if the brightness value of the pixel in Img_gray is lower than Th_bound, the brightness value of the corresponding pixel in Img_fore2 is set to 255, and if it is higher than Th_bound, it is set to 0; 7. Combining Img_color and Img ROI, the foreground image IMG FORE3 is detected: (1) traversing every pixel in Img_color; If the brightness value of the Img_ROI map corresponding to the pixel position is 0, no processing is performed; Otherwise, if only one of the three RGB values of the pixel in the position in Img_color is less than the threshold value Th_bound, the brightness of the corresponding pixel value in Img_fore3 is set to 255, and is set to 0 unless all three RGB values are less than Th_bound; (4) Img_fore2 and Img_fore3 are fused into foreground image Img fore4; by OR operation of the image; 8. Analysis of connected domain for Img_fore4: (1) if the number of connected domains is less than 16, warning and reminding the user; (2) filling the internal holes of each connected domain; (3) calculating the area of all connected domains; (4) extracting the 16 connected domains with the largest area; If the areas of the 16 connected domains are all larger than Th_area_patch, the following steps are carried out; Otherwise, the warning reminds the user; (5) calculating and obtaining the region of interest map Bound_ROI_i of each connected domain, and setting the pixel value inside the connected domain to 255; 9. Set the detection threshold Th_bound_inner of the internal region of the test strip to 50; 10. Obtaining a more accurate region of interest map BOUND ROI FINE I for each test strip block: (1) traversing each pixel with a brightness value of 255 in Bound_ROI_i; (2) if the brightness value of the corresponding pixel in Img_gray is higher than Th_bound_inner, the brightness value of the corresponding pixel in Bound ROI fine i is set to 255; Otherwise, if there are three RGB values of the pixel in the position in ling color, as long as there is one higher than

Th_bound_inner, the brightness value of the corresponding pixel in Bound ROI fine _i is also set to 255; Otherwise, the brightness value of the corresponding pixel in Bound_ROI_fine_i is set to 0; (4) performing connected domain analysis in Bound ROI fine i, and if there is no connected domain, warning and reminding the user; (5) filling internal holes in the detected connected domain; 11. Corrosion operation is carried out on the foreground region corresponding to the connected region on the region of interest map Bound_ROI)_fine _i of the test strip. The morphological operator has a side length of 5 pixels and a square operator.

The specific steps of the second algorithm module in SS04 are as follows:

SS0421: filter out the part overlapped with the image edge from the outer contour of the test strip 401 to obtain the intersection point of the outer contour and the image boundary as the lower left corner and the lower right corner of the test strip;

SS0422: calculate the included angle between each contour point and the contour point with the front-back distance NN=20;

SS0423: take the two contour points with the smallest included angle value among all contour points as the upper left corner and upper right corner of the test strip 401;

SS0424: connect the lower left corner, the upper left corner, the upper right corner and the lower right corner in sequence to judge whether the lines meet the parallel and vertical relationship;

SS0425: judge whether the test paper 401 is vertically placed. The detailed steps are as follows: 1. Set the outline point sequence of the outer frame of the test strip according to the counterclockwise direction of the outer frame of the test strip. Remove the part of the contour point sequence that coincides with the image boundary: a. scan from left to right along the image boundary to find the first contour point whose distance to the image boundary is less than 5 pixels, and record it as Pt1; B, scanning from right to left along the image boundary to obtain the first contour point whose distance from the image boundary is less than 5 pixels, which is marked Pt²; C, removing outline points of the outline sequence of the outer frame of the test strip which are positioned between the points Pti and Pt2 and overlap with the image boundary; D, rearranging the outline sequence of the test paper so that the sequence is counterclockwise, and ensuring that the starting point is Pt2 and the key point is Pt1;

2, starting from points, traversing each contour point in a counterclockwise sequence, calculating the angle ci: a of the contour points, and setting the spacing n to be 20; b, according to the counter-clockwise direction, find the n-th_N pixel after the contour point Pti , and record it as Pt_next_; c, finding the fifth pixel in sequence before the contour point Pti , and recording as Pt_ pre ; d, connecting Pti and Pt_next to obtain a straight line L1; e, connecting Pti and Pt _pre to obtain a straight line L2; f, calculating an included angle between 1 and L2 to obtain an included angle ci, of which the included angle ci takes the angle less than or equal to 180 degrees; g, the length of the contour point sequence is: EN; If the sequence number of the contour point Pti is less than N or greater than Len_N the angle value of the contour point Pti is directly recorded as 180 degrees;

3. Find the two contour points with the smallest angle value among all to contour points, and record them as contour point Corner1 and contour point

Corner2 respectively. Take these two contour points as the upper left corner and upper right corner of the test strip; Using contour points Corner2, Corner2, Pt1 and Pt2 , the contour of the test strip is divided into three sections. They are respectively the left boundary Line left Line the upper boundary topand the right boundary Line right .

4. Analyze the straightness of three boundaries: as long as the straightness V_line of one of the three boundaries is less than the threshold value of 0.9, it indicates that there is a problem with the test strip and gives early warning. The calculation method of straightness is as follows: A. Connecting the first and second points of the boundary to form a straight line L0; B, counting the number of points in the boundary contour points whose distance to a straight line is less than a threshold value, of which the threshold value is 5 pixels by default and is recorded as N_near_line; C. the number of contours of the boundary is N_contour; D. straightness

$$V\_line = \frac{N\_near \_line}{N\_contour} ;$$

If the included angles between the left boundary and the right boundary and the vertical direction are greater than 5 degrees respectively, the insertion direction of the test strip is inclined and early warning is required. If the included angle between the upper boundary and the horizontal line is greater than

Th_Angle (5°), the insertion direction of the test strip is inclined and early warning is required. If the angle formed by the left boundary and the right boundary is less than the threshold (5), the left and right boundaries are parallel. Otherwise, early warning is needed; Calculate the angle values of the upper left corner and the upper right corner. If any of them is less than 85 degrees or greater than 95 degrees, it means that the angle is not a right angle and requires early warning.

The specific steps of the third algorithm module in SS04 are as follows:

SS0431: 1 Minute Continuously Captures 20 Images with Urine Testing Device;

SS0432: calculate the average value of RGB three channels of each picture;

SS0433: find the median value of the average value of each channel in 20 maps;

SS0434: filter images with large difference between average value and median value;

SS0435: calculate the average image of the remaining images;

SS0436: filter color noise in average image;

SS0437: filter the bright reflection points caused by the light source;

SS0438: filter shadow pixels and low brightness pixels;

SS0439: filter pixels with large gradient values;

SS04310: all gray pixels on the test strip bottom plate 301 are detected;

SS04311: calculate an average value for all gray point pixels to obtain a target value for color correction;

SS04312: use the target value to correct each pixel and color in RGB channels at the same time;

SS04313: average filters pixels with corrected color values higher than 255.

The detailed steps are as follows: 1. The urine detection device automatically and continuously captures N=20 images with a time interval of 2 seconds each time.

2. Calculate the average illumination intensity of N images, and filter low illumination images and overexposed images. The specific steps are as follows:

(1) For each image, calculate the average value of RGB three channels of the image:

$$\overline{R} = \frac{1}{{N}_{pixel}} {\sum }_{x , y} R ( x , y ) , \overline{G} = \frac{1}{{N}_{pixel}} {\sum }_{x , y} G ( x , y ) , \\ \overline{B} = \frac{1}{{N}_{pixel}} {\sum }_{x , y} B ( x , y ) ,$$

where Nₚᵢₓₑₗ is the total number of pixels in the image. (2) for the R_aver of n images, sort them from big to small, and then get the median R_median. (3) traverse each R_aver. If the difference between the absolute value of this value and the absolute value of R_median is greater than 10, then the graph is considered abnormal and needs to be filtered out. (4) For G and B color channels, the same method is adopted to calculate the median value and filter abnormal images. (5) The total number of

$${N}_{2} < \frac{N}{2} ,$$

normal images remaining at this time is . If it needs to be taken again. Otherwise N₂, the average image is calculated using the remaining images:

$${R}^{′} ( x , y ) = \frac{1}{{N}_{2}} {\sum }_{i = 1}^{{N}_{2}} {R}_{i} ( x , y ) , {G}^{′} ( x , y ) = \frac{1}{{N}_{2}} {\sum }_{i = 1}^{{N}_{2}} {G}_{i} ( x , y ) , \\ {B}^{′} ( x , y ) = \frac{1}{{N}_{2}} {\sum }_{i = 1}^{{N}_{2}} {B}_{i} ( x , y )$$

3. The median filter is used to filter the color noise in the average image.

4. Detection of light source reflection points in the average graph: every pixel of img_mean is traversed. If the following three conditions are met at the same time, the pixel value at the same position in img_GLINT_ROI is set to 0. Where Th_GLINT is 250:

R(x,y)≥Th_GLINT&&G(x,y)≥Th_GLINT&&B(x,y)≥Th_GLINT

5. Detection and filtering of shadow pixels and low brightness pixels in the average image: if each pixel satisfies the following three conditions at the same time, the pixel value at the same position in the shadow pixel image img shadow ROI is set to 0.

R(x,y)≤Th_shadow&&G(x,y)≥Th_shadow&&B(x,y)≥Th_shadow

where Th_shadow is the empirical threshold (default is 20).

6. Filtering of pixels with large gradient values around the test strip: (1) carrying out gray scale conversion on img_mean to obtain img_mean_gray.(2) calculating gradient amplitude using Sobel operator in img_mean_gray

Gₓ(i,j)=|I(i,j)−I(i,j−1)|, I(i,j)−I(i−1, j)|, G(i,j)=Gₓ(i,j)+G_{y}(i,j)

Where Gₓ(i,j) is the gradient amplitude in the horizontal direction, G_{y}(i,j) is the gradient amplitude in the vertical direction, I(i,j) represents the pixel brightness value at (i,j) position, and G(i,j) is the gradient amplitude of the pixel at (i,j) position. (3) every pixel of the current average image img_mean is traversed, and if the following condition G(i,j)Th gradient is met, the pixel value at the same position in the edge pixel ROI image img_gradient_ROI is set to 0. where Th-gradientthe empirical threshold (default is 40).

7. Detection of gray point pixels (RGB value difference is not more than 20) on the test paper base plate: the position of each test strip has been obtained in the previous step, so only the position other than the test strip in img_mean needs to traverse each pixel, and if the following three conditions are met, it is added to the set S:

img_GLINT_ROI(x,y)==255

img_shadow_ROI(x,y)==255

img_gradient_ROI(x,y)==255

8. Color correction for average image img_mean: For all gray point pixels in set S, calculate their respective average values on R, G and B channels. Then select the maximum value as the target value for color correction:

Val_max=max(R_aver, G_aver, B_aver)

Calculate the correction coefficients of each of the three channels R, G and B:

$$R\_ratio = \frac{R\_aver}{Val\_max} , G\_ratio = \frac{G\_aver}{Val\_max} , B\_ratio = \frac{B\_aver}{Val\_max}$$

Each pixel in img_mean is traversed and its color value is corrected:

$${R}^{′} = \frac{R}{R\_ratio} , {G}^{′} = \frac{G}{G\_ratio} , {B}^{′} = \frac{B}{B\_ratio}$$

Where, for the current pixel, the corrected values of R, G and B channels.

9. Processing in case the pixel value exceeds 255 after color correction: the

average value of RGB values of 8 pixels in 8 neighborhoods around the pixel is used as the RGB value of the pixel. Then, Gaussian smoothing is performed on the resulting image to eliminate the possible visual discordance during color correction.

The specific steps of the fourth algorithm module in SS04 are as follows:

SS0441: collect test paper 401 samples by manually configuring reagents with different concentrations;

SS0442: collect users' real test samples through the network;

SS0443: cut a 0.5 mm wide area around each test strip 401;

SS0444: HSV, RGB and normalized RGB color spaces are selected as features at the same time.

SS0445: comprehensively calculate the color similarity of two pixels from three color spaces;

SS0446: set up a color subset for each detection item, and use the mean shift algorithm to complete the clustering of color values, and set up a Gaussian model for each color subclass;

SS0447: analyze each pixel on the current test strip 401 to determine the probability that it belongs to each color subclass;

SS0448: gaussian model is used for noise filtering, and if the number of remaining pixels is less than 10%, early warning is given;

SS0449: use multiple snapshots to compare the image changes of test paper 401 and determine the most accurate time for identification;

SS04410: synthesize all pixels on the current test strip 401 to obtain the probability that the test strip 401 belongs to each reference class and obtain the final recognition result.

The detailed steps are as follows: 1. Large-scale collection of test samples for test strips: (1) Through manual configuration of corresponding reagents with different concentrations, the test paper strips are soaked therein to obtain corresponding sample sub-images (for example, more than 1000 sub-images corresponding to each test strip). (2) Collection of user real test samples. After the urine test instrument is put into real use in the market, the images captured by the user during each test can also be saved in the cloud database during the process of the user testing the urine index.

2. Treatment of peripheral light-colored areas in the sub-image of the test strip: Narrow strips with a width of 0.5 mm are cut out on the upper, lower, left and right sides of the sub-image corresponding to the test strip, so that the actual size of the central area of the test strip finally used for color identification is 4 mm*4 mm

3. Selection of color space: (1) Defect of 1)HSV color space: Take the case of R==max as an example, when the value of max−min is very small (e.g. less than 20), it is easy to cause instability of hue value. This is because the denominator is very small at this time, and a small change in the numerator can cause a large change in the whole score value. When max==min, the value of h cannot be calculated, and the denominator is 0. At this time, the hue value is very unstable. In order to make up for this defect of hue value, the invention introduces normalized RGB space. (2) Normalized RGB color space: In RGB color space, the correlation of R, G and B color values is very high, and it is easily interfered by illumination. They cannot stably describe the reflectivity of the object surface. In order to eliminate the interference caused by illumination changes, the normalized RGB color space takes the sum of the three RGB channels as the illumination value, and then calculates the proportion of each color channel to

$$r = \frac{R}{R + G + B} , g = \frac{G}{R + G + B} .$$

obtain three normalized color features: r, g, b: However, normalized RGB color space still has defects. When the value of R+G+B is very small, such as below 40, the calculation of r and g is still unstable. At this time, it is necessary to directly use RGB color space to express colors. (3) the comprehensive application of three color spaces: (a) extracting hue feature h from HSV color space; (b) if the H feature is unstable, extracting R and G features in the normalized RGB space; (c) if the features r, g are unstable, extracting the r, g, b features directly from RGB space;

4. Calculation of the color similarity of the two pixels: (1) Judge whether the hue characteristic H is stable, i.e. if the difference between max and min is greater than 50: if it is stable, directly use the hue values h1 and h2 of the two colors to make the difference. The greater the difference, the lower the similarity. The color difference is calculated as follows: dist=|h₁−h₂|. (2) If the hue characteristic is unstable, compare the difference between R and G of the two pixels. The smaller the difference is, the closer the colors of the two pixels are. dict=|r₁−r₂|+|g₁−g₂|. (3)r and G are unstable, that is, the sum of R, G and B is less than 20. At this time, directly compare the differences of r, g and b. The smaller the difference, the closer the two color values are dist=|R₁−R₂|+|G₁−G₂|+|B₁−B₂|;

5. For each detection item (one row on the color comparison card, including several reference color blocks), the candidate color set is established: the sample with the corresponding concentration of the current detection item in step 1 is assigned to the sample subset S. Analyzing all sub-image blocks in the sample subset S, extracting all pixels in the sub-image to obtain the color subset S_patch; The color subset includes all possible colors in the reference range corresponding to the reference block, and the probability that each color belongs to the reference block can be calculated. Taking a certain type of colorimetric card as an example, there are a total of 5 reference color blocks on the colorimetric card for glucose as a detection item. Then it is necessary to establish 5 color subsets for glucose. The establishment process of one color subset S_patch_sugar_i as follows: (1) The index value range of the current reference color block is extracted from the color comparison card. Relevant information is recorded on the color comparison card. (2) attributing all the image samples collected in step 1 that belong to the concentration range to a sample image subset S_image_i; (3) for each image in the sample image subset S_image_i, detecting and filtering reflective points; (4) extracting all pixels in each image in the sample image subset S_image_i, and calculating color characteristic values thereof; (5) Clustering all color feature values in the image subset S_image_i, by means of mean shift clustering method. The number of subclasses of each subset is set to 10: (a) the initial center positions of 10 classes are randomly set; (b) setting the size of the search window; (c) iteratively searching to find the position with the largest sample density in the window as the new window center every time; (d) repeating the iteration until the center position of any class is no longer changed; (e) classifying all pixels according to the final center positions of the 10 classes to obtain 10 subclasses. (6)

Using the classification results and the color features of all pixels, a Gaussian probability model is established for each subclass. A Gaussian probability model is established for the current subclass from six features of R, G, B, Hue, R and G

6. Identify the color of the test strip to be detected at present: (1) traversing each reference color block on the color comparison card to obtain standard color characteristics R, G, B, Hue, R, G; (2) traversing each pixel on the current test strip and extracting the color characteristics of the pixel: R, G, B, Hue, R and G; (3) judging whether each pixel on the test strip is noise by using a probability method: (a) calculating the probability that the current pixel belongs to each reference class by using the color characteristics, the clustering result obtained in step 5 and the Gaussian probability model; (b) filtering the pixel as noise if the probability that the pixel belongs to any reference class is lower than 0.001. (4) calculating the probability that the current pixel is classified into each corresponding reference class on the color comparison card. The reference class with the highest probability is selected as the classification result: (a) the probability that the current pixel belongs to each reference class is calculated by using the color feature, the clustering result obtained in step 5 and the Gaussian probability model; (b) comparing the probabilities of all reference classes, and taking the sequence number of the reference block corresponding to the maximum probability value as the classification result of the pixel; (c) selecting the reference class with the highest probability as the classification result of the pixel. (5) calculating the classification result of the whole test strip: (a) counting the classification result of each pixel to obtain a classification histogram; (b) calculating the probability that the test strip belongs to each reference class according to the classification histogram. The calculation method is

$${P}_{i} = \frac{{c}_{i}}{N} ,$$

where the probability that the test strip belongs to the I reference class. cᵢ is the number of pixels classified as the I-th reference class in the test strip image. N is the total number of all pixels in the image. (c) among all the reference

$$class\_id = {max}_{i} ( {P}_{i} )$$

probabilities Pᵢ, the reference class with the highest probability is selected as the final color recognition result class of the test strip; (d) the index value corresponding to the current test strip is calculated. This result is obtained by weighting the index values of each reference block.

$$\text{RESULT} = {\sum }_{i = 1}^{N} ( {P}_{i} \times r e {s}_{i} ) .$$

Where resᵢ is the index value corresponding to each reference class. P is the reference class probability. N is the number of reference classes.

7. If the total number of remaining pixels N of the current test strips is less than 10% of the real number of pixels of the test strips after filtering various noises, it indicates that the test strip has abnormality and needs to be warned to remind the user to re-detect.

8. Check whether the chemical reaction is sufficient or not by taking multiple images captured by urine analyzer: (1) Analyze the 20 images captured in step 7. (2) For a certain detection item, analyze the content changes of these 20 sub-images. Each sub-image is differentiated from the corresponding sub-images in the first and second frames respectively, and the total number of pixels that have changed is counted. The details are as follows: (a) Compare the current image with the previous frame sub-image pixel by pixel, judge how many pixels are different, and record the total number of different pixels. Two pixels are considered inconsistent if the following conditions are met:

Where R₁(x,y) represents the r value of the (x,y) position of the current frame, R₂(x,y) represents the r value of the (x,y) position of the previous frame, G₁(x,y) represents the g value of the (x,y) position of the current frame, and G₂(x,y) represents the g value of the (x,y) position of the previous frame. B₁(x,y) represents the B value of the (x,y) position of the current frame and B₂(x,y) represents the B value of the (x, y) position of the previous frame. A pixel of the current picture and the previous frame picture can be considered to have changed as long as the difference in color values of any one of the RGB three channels is too large. Where Th_diff is an empirical threshold, set to 10.(b) count the number of pixels different from the previous frame graph N₁. count the number of pixels different from the current graph and the next frame graph N₂. count the total number of unstable pixels in the current graph, with the formula N=N₁+N₂. (4) for the current detection term, traverse all its corresponding sub-images, and detect the sub-image with the least pixel number change (the smallest value of n) as the most stable moment.

In the description of this specification, the description referring to the terms “one embodiment,” “an example,” “a specific example,” and the like means that a specific feature, structure, material, or characteristic described in connection with the embodiment or example is included in at least one embodiment or example of the present invention. In this specification, the schematic representation of the above-mentioned terms does not necessarily refer to the same embodiment or example. Moreover, the specific features, structures, materials, or characteristics described may be combined in any one or more embodiments or examples in a suitable manner. The preferred embodiments of the present invention disclosed above are only for the purpose of helping to illustrate the present invention. The preferred embodiment does not set forth all the details in detail, nor does it limit the invention to the specific embodiments described. Obviously, many modifications and variations are possible in light of the contents of this specification. These embodiments are selected and described in detail in this specification in order to better explain the principle and practical application of the present invention, so that those skilled in the art can better understand and utilize the present invention. The present invention is limited only by the claims and their full scope and equivalents.

1. As for the portable urine testing device and method, there are not only hardware parts including box, slot, base and baseboard, but also spare parts including OTG USB cable and 14 urine test strip. Below are their features:

2. As described by claim 1, the main body as an element of hardware parts is an enclosed square box made of light-tight materials. The box has a main control board at its inner top, consisting of camera module and LED light. The box is equipped with a USB hole at the outer lateral wall, where there is also a slot hole at its lower part.

3. As described by claim 1, the slot module as an element of hardware parts is composed of slot, base and baseboard. The baseboard linked to the box by way of buckle constitutes a testing box with a front opening together with the upper part of the urine tester's box. The base is screwed with the baseboard. The slot inserted in the urine tester through the opening as mentioned above is connected with the baseboard as well. The slot, including main plate intended for 14-indicator urine test strip, has a symmetrical design. There are raised enclosures around slot's main plate, two long and two short. At the outer side of the two long enclosures is a mutually symmetrical U-shaped groove. The tip at the top of the enclosure facing inner side of the slot constitutes a surrounding structure. There is a long sagging part along the central axis of the slot's main plate, which is used to store the small test strips furnished with reagent blocks in a single row. The base is armed with locating gate, slot's fixer, and baffle buckle, with locating gate designed at the side of the base near the testing box's opening. The slot's fixer is comprised of symmetrically arranged buckles characterized by reverse L-shaped structure, as well as movable clamps. The end of the buckle facing inner side of the slot has an enclosed structure, and in the middle of the movable clamp is a raised pillar, its two sides bent backwardly. Meanwhile, the movable clamp is connected with the buckle at one end and fixed to the base at the other end. The raised pillar in the middle has no connection with the base and the baffle buckle is located at the side of the base far away from the opening of the testing box.

4. As described by claim 1, the OTG USB cable as an element of spare parts connected with smart phone is used for device testing. It can provide power for tester's built-in camera module and LED light. The OTG USB cable furnished with a main control chip intended to control data transmission can transmit not only image and vide data in UVC camera to smart phone, but also instructions of smart phone to camera for image capturing. In test, users may connect OTG USB cable with test device and smart phone. Then, test device's LED light will be turned on and the camera will be started automatically as well. After the test, the LED light and the camera will be turned off automatically when OTG USB cable is unplugged.

5. As described by claim 1, the 14-indicator urine test strip consists of reagent blocks and long white thin substrate, which has an all-in-one rectangular plate and handle. The test paper has several small reagent blocks arranged in an equidistant way. The rectangular plate is located outside every reagent and there are black outer boxes near small reagent blocks. There is an indicating line along the width of the test paper in the middle as well as an arrow icon along its length in the lower middle. Under the arrow icon, there is a sign of “this side up”. Besides, the corner has a smooth comer.

6. As for the portable urine test device and method, the algorithm module has reagent block location algorithm module, the algorithm module judging whether the test paper is skew, color correction algorithm module, color identifying algorithm module. Their features are as follows:

7. As described by claim 6, the reagent block location algorithm has following steps: (1) threshold value is used for binaryzation of images; (2) the connected domain in binary image is applied as test paper's domain; (3) the binaryzation is used to work out reagent block's black outer box within test paper's domain; (4) there will be 16 warnings in the case of insufficient black outer boxes; (6) binaryzation will be performed in every black outer box to figure out reagent block domain; (6) the reagent block domain will be refined by way of corrosion.

8. As described by claim 6, the algorithm module locating test strip and judging if the inserting direction is skew has following steps: (1) the part overlapping with image edge shall be filtered out from the outer contour of the test strip to figure out the points of intersection between contour and image edge, and they shall be set as lower left corner and lower right corners, respectively; (2) the angle between every contour point and the contour point which is N (N=20) away from the contour point mentioned before; (3) the two contour points with smallest angle shall be designed as upper left corner and upper right corner of test strip; (4) the four corners above shall be linked together to judge whether the lines are parallel or vertical to each other; (5) there is a need to judge whether the test strip is placed vertically.

9. As described by claim 6, the color correction algorithm has following steps: (1) 20 images of urine tester shall be captured within 1 min; (2) average value of every image's three RGB channels shall be figured out; (3) mid-value of every channel's average value in the 20 images shall be worked out; (4) the image with large difference between average value and mid-value shall be omitted; (5) the average image of the rest images shall be calculated; (6) color noise of the average image shall be filtered; (7) the specially bright reflecting points shall be filtered; (8) shadow and low brightness pixels shall be filtered; (9) large gradient pixels shall be filtered;
(10) all gray dot pixels at the baseboard of test strip shall be tested; (11) average value of all gray dot pixels shall be calculated to find the target value of color correction; (12) target value will be used for color correction of every pixel in three RGB channels; (13) average filtering shall be performed for pixels whose color value is higher than 255 after correction.

10. As described by claim 6, the color identifying algorithm module has following steps: (1) reagents with different densities are prepared manually to acquire reagent block samples; (2) user's true test samples are acquired through the Internet; (3) every reagent block shall be made square and 0.55 mm-wide; (4) three color spaces including HSV, RGB and normalized RGB shall be taken as characteristics; (5) color similarity of two pixels shall be calculated according to three color spaces; (6) color subset shall be built for every test item and mean shift algorithm shall work out the cluster of color value to create Gaussian Model for every color subset; (7) every pixel of reagent block shall be analyzed to judge the possibility of every color subset; (8) Gaussian model shall be used for noise filtering; there shall be warning when the number of the rest pixels are lower than 10%; (9) images shall be captured multiple times to compare image variations of corresponding reagent blocks and then to decide the most accurate time of identifying; (10) all pixels of current reagents shall be summarized to figure out the possibility of reagent blocks in every class and then obtain the final identifying results.

11. As for the portable urine testing device and method, its software module, known as cloud and software system module, has following features:

12. As described by claim 11, the cloud and background software system is composed of the sub-modules below: (1) cloud database performs backup of all user's historical data, which can be deleted, inserted and edited by users, and the system will synchronize cloud data with mobile data automatically; (2) doctor software module can arrange doctors for patients, who will provide guidance and timely diagnostic service for them on the Internet; (3) patient software module can keep test records offline and patients are allowed to check any historical records; when there is a network connection, the data can be uploaded to cloud automatically so that users will be reminded of timely test and the test results can be heard; this software can manage multiple test tasks and strips, and provide medical advice and different kinds of information and knowledge according to test results; test strips can be also bought from the software; (4) friend-and-relative software module allow friends and relatives to provide real-time guidance for the old patients to complete urine tests and read patient's testing data in real time; (5) social module can guarantee unobstructed communication between patients and doctors and arrange doctors for patients; (6) intelligent customer service sub-system builds a Gaussian possibility module for answers of every keyword; it offers the most possible answers for users after analyzing possibility of every keyword's answer according to user's questions; provided users are unsatisfied with the answers, man will be arranged to give an answer; (7) patients can have conversations with each other in the group; (8) as for hot issues discussed in patient group, frequency of keywords can be sequenced and the keyword list can be kept manually to perform automatic analysis on hot issues; (9) user's test information can be shared in social network; (10) cloud's intelligent module analyzes the difference between patient's current test data and historical average data to judge their health condition.
